(19) United States
(12) Patent Application Publication
(10) Pub. No.: US 2016/0072430 A1
(43) Pub. Date: Mar. 10, 2016

(54) DEVICE FOR LIGHTING OR BACKLIGHTING AN IMAGE PLACED IN FRONT OF OR BEHIND A SOLAR PANEL

(71) Applicant: SUNPARTNER TECHNOLOGIES, Aix en Provence (FR)

(72) Inventors: Joel GILBERT, Aix en Provence (FR); Olivier GAGLIANO, Aix en Provence (FR); Badre KERZABI, Aix en Provence (FR); Robert MONTEILLIER, Aix en Provence (FR)

(73) Assignee: SUNPARTNER TECHNOLOGIES, Aix En Provence (FR)

(21) Appl. No.: 14/783,905

(22) PCT Filed: Apr. 10, 2014
(86) PCT No.: PCT/FR2014/000080

§ 371 Date: Oct. 12, 2015

(30) Foreign Application Priority Data
Apr. 10, 2013 (FR) 13 00847

(51) Int. Cl. H02S 30/10; G09F 23/00; F21V 8/00

(52) U.S. Cl. CPC H02S 30/10; G02B 6/005; G02B 6/0095; G09F 23/00

(57) ABSTRACT

The invention relates to a device including a solar panel, a transparent plate serving as a light guide, an image consisting of multiple opaque or semitransparent image areas separated by totally transparent areas or micro-holes exposing said solar panel, wherein said image is printed on or directly arranged against said transparent plate, and a light source propagates the light thereof within the body of said transparent plate. Said device is particularly characterized in that said transparent plate comprises optical means arranged so as to redirect most of the light injected by said light source towards the image areas.

The present invention relates to devices that allow partially transparent images that are positioned in front or behind a solar panel to be illuminated.

### PRIOR ART

Most photovoltaic or thermal solar collectors are dark or even black in color in order to collect as much light from the sun as possible. However, in order to disseminate visual information positioned on their surface or in order to make them more attractive and allow them to better integrate visually into their environment, or indeed even to make them suitable for communicating visual messages or images, it would be advantageous for said collectors to appear a wider variety of colors or indeed display images and hence no longer appear uniformly black or dark.

Techniques already exist that allow either a photovoltaic solar collector to be made partially transparent so that it lets some of the light that it receives pass, or an image covering said collector to be made partially transparent so that the solar collector receives at least some solar radiation.

Moreover, document WO 2007/85721 relates to an optical system that allows an image to be viewed on the surface of a solar panel without this image forming an obstacle to the direct solar rays that must reach the solar panel. It consists of a solar panel, of a lenticular surface formed from rectilinear lenses and of a transparent film on which is printed an image from which rectilinear bands lying parallel to the longitudinal axis of the lenses have been removed. At certain viewing angles an observer sees only the image bands whereas at other angles of incidence solar rays pass through the transparent bands and reach the active area of the solar collector.

This document makes a decisive contribution to the visual integration of solar panels into their environment. However, it does not address the problem of illumination of the displayed image, which may prove to be necessary in certain circumstances, for example at night, or under poor ambient lighting conditions.

Furthermore, these images, because they are necessarily semitransparent to light, or because they are positioned behind a solar panel, cannot be illuminated with conventional lighting because such lighting would either be ineffective or would not be transparent enough to solar radiation, the aim being for the illumination device to intercept only a small portion of the sunlight illuminating the solar panel.

Moreover, a photovoltaic device allowing both light energy to be converted into electrical current and an image to be illuminated is known from document WO 2011/114262, this dual effect being obtained by superposing photovoltaic elements certain of which are dedicated to the current generation function and others of which are dedicated to the display of information. The effectiveness of this device may be increased with a set of reflectors allowing a light energy concentration effect to be obtained. However, this document does not describe optical means for obtaining, simply and using a single photosensitive layer, both generation of a current via the photovoltaic effect and illumination of an image printed on or placed against a carrier.

### AIM OF THE INVENTION

Therefore, the main aim of the invention is to improve either the illumination of an image that is positioned behind a semitransparent solar panel, or that of a semitransparent image that is placed in front of a solar panel, while making sure that the illumination device does not form much of an obstacle to the solar rays that pass therethrough. Specifically, the solar radiation that passes through the image or solar panel must also activate the solar panel with the minimum of losses in order for it to continue to generate a significant amount of electrical power. Therefore, the device according to invention also aims to form the smallest possible obstacle to this incident solar radiation, since it is the root cause of the expected power generation.

Another aim targeted by the device according to the invention is to decrease the electrical current that is required to illuminate the image and therefore the overall electrical power consumption of the light source used to illuminate the image in front of or behind the solar panel, thereby especially allowing devices to be designed that display illuminated images while nonetheless being autonomous from the point of view of power supply.

### DESCRIPTION OF THE INVENTION

Basically, the invention comprises a light source, which is preferably artificial, and a device or transparent sheet provided with optical means suitable for redirecting this light toward the front of an image placed behind or in front of a solar panel, while modifying very little the amount of sunlight received by said solar panel.

The expression “image printed on a transparent sheet” generally designates, in order to simplify the description, that the pixels of the image are placed in contact with a transparent sheet, and it is not intended to be understood as limiting the technology used to produce the image, which may be printing or another technology.

The image may also by extension be an electronic image provided that it comprises at least one surface able to be placed in contact with one of the faces of said transparent optical sheet. The image may then for example be of the LCD, LED, OLED, plasma or even e-ink or electrophoretic-ink type.

In its basic version, the device according to the invention comprises a solar panel and a transparent optical sheet on which is formed an image, for example by printing, so that there is no air gap between the transparent optical sheet and the image. Said printed sheet is positioned behind or in front of the active area of the solar panel and comprises a multitude of image zones that may be completely opaque or partially transparent or completely transparent to sunlight, it being understood that the various image zones may be of different transparencies.

A light source is positioned on the periphery of the optical sheet and illuminates the edge face of said sheet in order to propagate light in its thickness. The sheet then plays the role of a wave guide for the light, which is unable to exit from the sheet except via its edges and via the image zones that are printed on one of the faces of the sheet. Specifically, the pixels or ink printed on one of the faces of the sheet have a refractive index similar to that of the sheet, thereby allowing the light to penetrate into this ink and to convey its color. Thus, the image zones will be illuminated without the transparent optical sheet or the lighting system forming an obstacle to incident solar radiation.

The various components of the preceding basic device may be combined with one another so as to create features suitable for improving the sought-after visual effects and especially suitable for improving the illumination of the image depending on its position relative to the solar collector.

Therefore, the subject of the invention is a solar device comprising a solar panel, a transparent sheet acting as a light guide, an image composed of a multitude of opaque or semitransparent image zones separated by completely transparent zones or micro-holes that let said solar panel appear, said image being printed on or placed directly against said transparent sheet, and a light source propagating its light in the thickness of said transparent sheet, characterized in that said transparent sheet comprises optical means arranged to redirect toward the image zones most of the light injected by said light source (4). In this way, the image being illuminated becomes much easier to see. Furthermore, the image is illuminated without there being an air gap between the light source and the image, so that almost all the light transmitted by the light source will therefore illuminate the image. Furthermore, the device for lighting the image does not disrupt transmission of sunlight to the solar collector.

A plurality of variants in the relative arrangement of the solar panel, image and transparent sheet provided with its optical means are possible.

According to one variant embodiment of the device, the transparent sheet is located in front of the image, and the latter is located in front of the solar panel from the point of view of an observer or ambient light.

According to another variant embodiment, the image is located in front of the transparent sheet, and the latter is located in front of the solar panel.

According to another variant embodiment, the transparent sheet and the image are located behind the solar panel, the latter then being semitransparent, or provided with micro-holes that let some ambient light pass toward the image.

There are a plurality of variant embodiments, depending on the location of the optical means of the transparent sheet. According to one variant, said optical means are located on the front face and/or back face of said transparent sheet and comprise micro-lenses and/or optical microstructures specially configured so that light that passes through the interior of said transparent sheet exits therefrom preferentially in the direction of the image zones, in an angular range that corresponds substantially to the angular range of observation of the device by the observer. In this way, only or mainly the image bands are illuminated, which become visible to the observer even at night, without illuminating the solar panel.

According to the invention, the microstructures of the transparent sheet consist of prisms or grooves in the transparent sheet. Preferably, the total area of said microstructures represents less than 10% of the total area of said transparent sheet.

According to one advantageous variant of the invention, the transparent sheet is composed of two subsheets, namely a first subsheet having its front face structured with an array of convex rectilinear lenses that lie parallel to one another, and a second subsheet the faces of which are parallel, said subsheet being positioned in front of the first subsheet, i.e. between the first subsheet and an observer or the sun, and the second subsheet having its front face, its back face, or both its faces optically structured with microstructures, the light of said light source being directed toward a lateral edge face of the first subsheet and/or second subsheet, but preferably toward a lateral edge face of the second subsheet.

More precisely, the microstructures of the second subsheet are configured so that the light that is injected into the second subsheet by the illuminating light source is preferentially scattered toward the lenses of the first subsheet at an angle such that said lenses redirect the light toward the image zones of the image without reaching the photovoltaic panel. In this way, the observer sees the image, without being perturbed by even partial vision of the solar panel.

In order to also ensure optimal operation of the device under ambient light, the lenses of the first subsheet are configured so that some ambient light, especially sunlight, is directed by the lenses essentially toward the completely transparent zones of the image so as to illuminate the photovoltaic panel and produce an electrical current.

According to one advantageous variant embodiment, the surfaces of the two subsheets make contact and these contacts form optical lines through which the light that propagates in the thickness of the second subsheet may pass in order then to have its radiation scattered toward the image and more particularly toward the image bands, in order to illuminate said image or said image bands from in front.

According to one embodiment of the device, the solar panel is positioned behind the transparent sheet and said image is on the whole semitransparent and is composed of a multitude of image zones that are optionally themselves opaque and that are printed onto the back face of the sheet, said image zones taking the form of parallel bands spaced apart by completely transparent bands, the front face of the sheet being optically structured with an array of convex rectilinear lenses that lie parallel to one another, the longitudinal axis of the lenses lying parallel to the image bands so that each lens has a corresponding image band near its focal plane, the illumination from in front of the image zones being achieved with light that travels through the interior of the transparent sheet, this light being injected via the edge face of one the two sides of the sheet that lie perpendicular to the longitudinal axis of the lenses.

According to another embodiment of the device, the solar panel is positioned behind the transparent sheet composed of two subsheets, a first subsheet being structured on its front face with an array of convex rectilinear lenses that lie parallel to one another, said image being composed of a multitude of image zones a first portion of which, taking the form of parallel bands spaced apart by completely transparent bands, is printed on the back of this first subsheet, and a second portion of which is printed on a transparent second subsheet the faces of which are parallel, said subsheet being positioned in front of the first subsheet, said first portion of the printed image preferably being opaque and preferably white (white underprint) and said second portion of the printed image (colored portion) being composed of a multitude of semitransparent image zones, preferably without the white underprint, this second portion of the image being printed on the front face or on the back face of said second subsheet, the illumination of said first portion of the image zones being achieved with light that is injected via the edge face of one the two sides of the first subsheet that lie perpendicular to the longitudinal axis of the lenses.

Advantageously, in this embodiment, the second portion of the image is also illuminated with light that is injected via the edge face of at least one of the four sides of said second subsheet and that travels through the interior of the second subsheet.

It may be advantageous, to simplify manufacture or decrease cost, for the first subsheet, including the printed image bands and optionally the lateral illumination device of said first subsheet, to be integrated into a protective front cover of the solar panel, or to replace this front cover.

According to one variant embodiment, said transparent sheet or said first and second subsheets are covered with a transparent protective film of low refractive index in order to increase the effectiveness of the light guiding effect.

The solar panel may be of various types or shapes and for example comprise a flexible or stiff, curved or planar, photovoltaic, thermal or hybrid solar collector. In one advantageous variant, the solar panel is a photovoltaic panel and its back face is made reflective, for example using the back electrode of the photovoltaic cells when said electrode is made of a metal, especially aluminum, silver or copper.

It will be noted that the device is not tied to particular dimensions, it is independent of the thickness of the photovoltaic cells, of the sheet, of the subsheets, of the lenses, of the pixels or of components of the lighting, these dimensions possibly being decreased to about 100 microns.

The illuminating light source is preferably configured to inject collimated light into the transparent sheet, said light being injected into the transparent sheet or into one or other of the subsheets at an angle smaller than 30° to the reflecting surfaces of the sheets. In this way it is possible to ensure that the light transmitted through the sheet exits only at the provided optical means in order to be effectively directed toward the image.

According to one variant embodiment, the transparent sheet consists of a sheet of optical fibers of various colors the surfaces of which have light scattering properties.

According to other variants, the transparent sheet is stiff or flexible and made of a mineral, organic or synthetic material.

The light source is of variable nature and it may be solar or artificial and of any color and any nature, it for example being a filament lamp, an LED lamp, an OLED, a fluorescent strip light, a laser or a neon lamp.

The image may also be of variable nature. When it is semitransparent, it is for example made up of colored pixels composed of inks, UV inks, or inks containing phosphorescent or metal additives so that the light is absorbed by one of the front or back faces of the pixels, then re-emitted from the other face of the pixels, possibly with another color.

Furthermore, the illuminated image may be a still or animated electronic image, for example of the LCD, OLED or plasma type, and its carrier preferably comprises a surface able to be placed in direct contact with the transparent sheet, in order to avoid optical losses in air gaps.

Another particular case is that where the photovoltaic electrical power produced by the device delivers the illumination of the image in real time, without recourse to a device for storing electrical power, therefore without batteries, accumulators or capacitors. This electrical self-supply will no longer serve only for nocturnal lighting but also for lighting during the day, for example in order to improve the brightness of the image and increase its visibility.

The invention is now described in more detail by virtue of the appended figures.

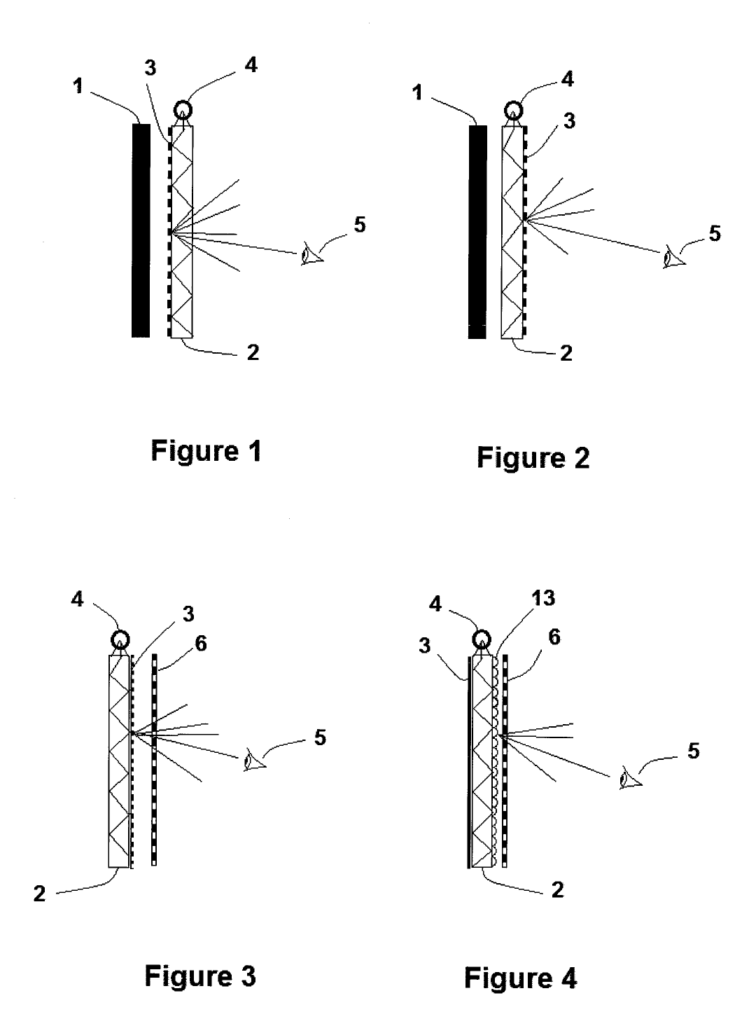

FIG. 1 is a cross-sectional schematic of the device according to the invention when the image consists of opaque zones and is positioned in front of the solar panel.

FIG. 2 is a cross-sectional schematic of the device according to the invention when the image consists of semitransparent image zones and is positioned in front of the solar panel.

FIG. 3 is a cross-sectional schematic of the device according to the invention when the image consists of semitransparent image zones and is positioned behind the solar panel.

FIG. 4 is a cross-sectional schematic of the device according to the invention when the image consists of opaque image zones and the transparent sheet is a lenticular sheet, the assembly being positioned behind a semitransparent solar panel.

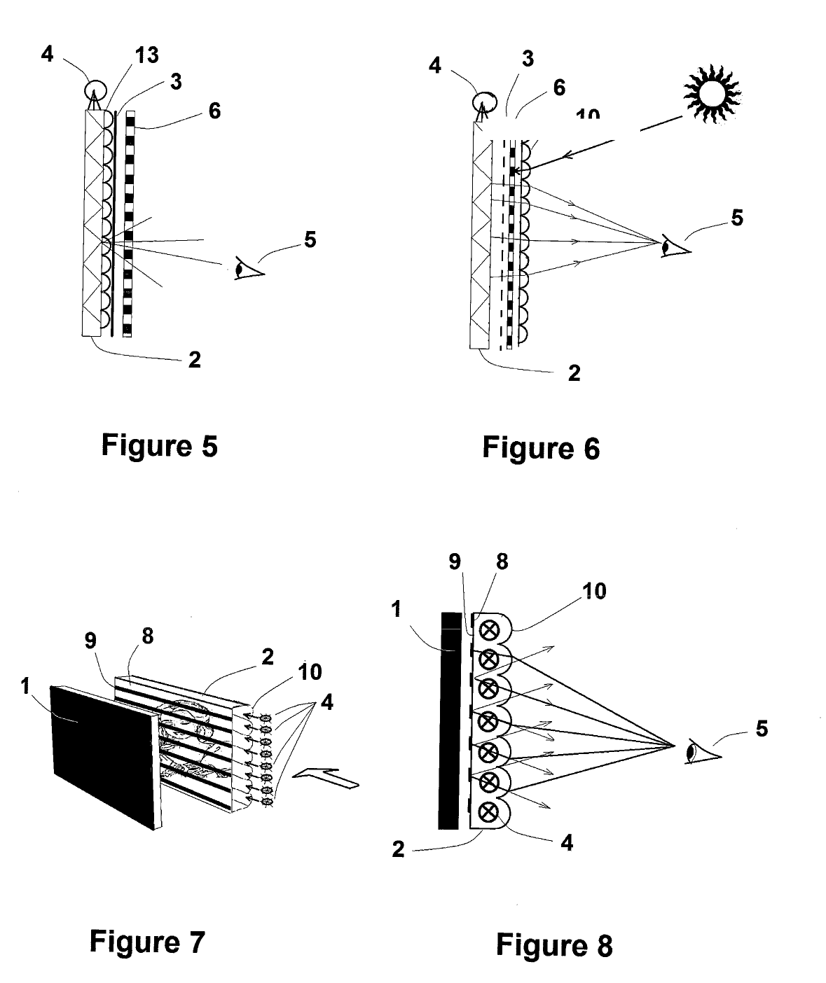

FIG. 5 is a cross-sectional schematic of the device according to the invention when the image consists of semitransparent image zones and the transparent sheet is a lenticular sheet, the assembly being positioned behind a semitransparent solar panel.

FIG. 6 is a cross-sectional schematic of the device according to the invention when the image consists of semitransparent image zones and the solar panel is also semitransparent, its two surfaces making contact with the front of the backlighting sheet and with the back of a lenticular surface.

FIG. 7 is a perspective schematic of the device according to the invention when the image consists of image bands printed on a lenticular sheet, the image and the sheet being positioned in front of the solar panel.

FIG. 8 is a cross-sectional schematic of the device in FIG. 7, which shows that the light illuminating the image is redirected mainly toward the observer.

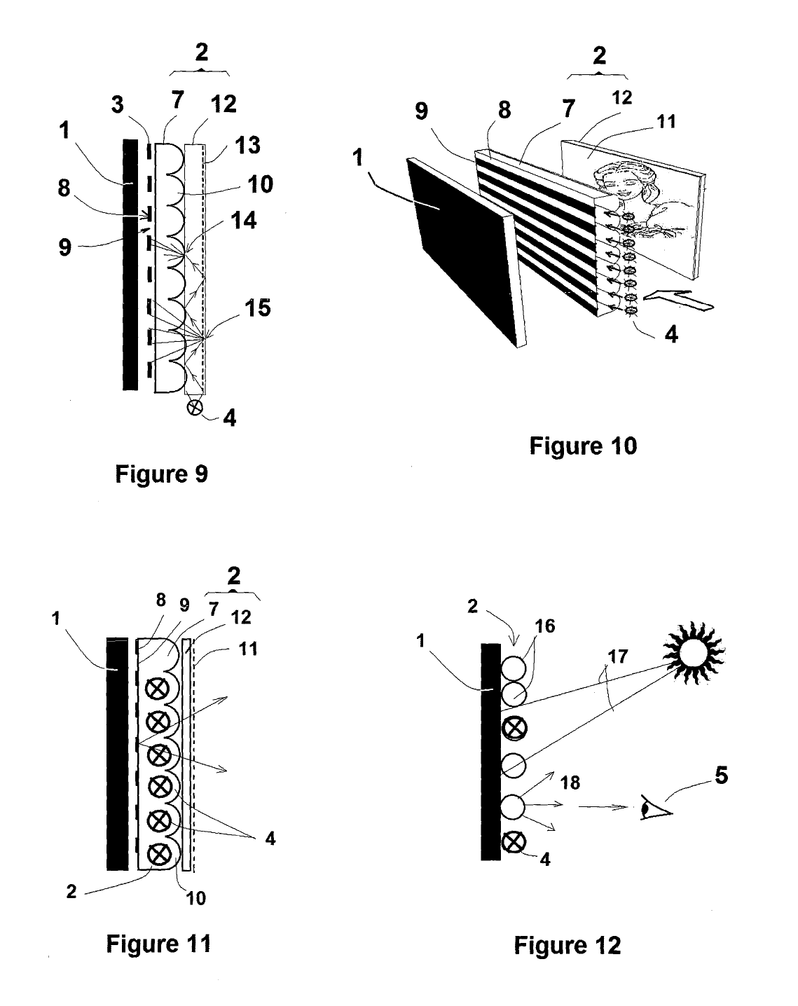

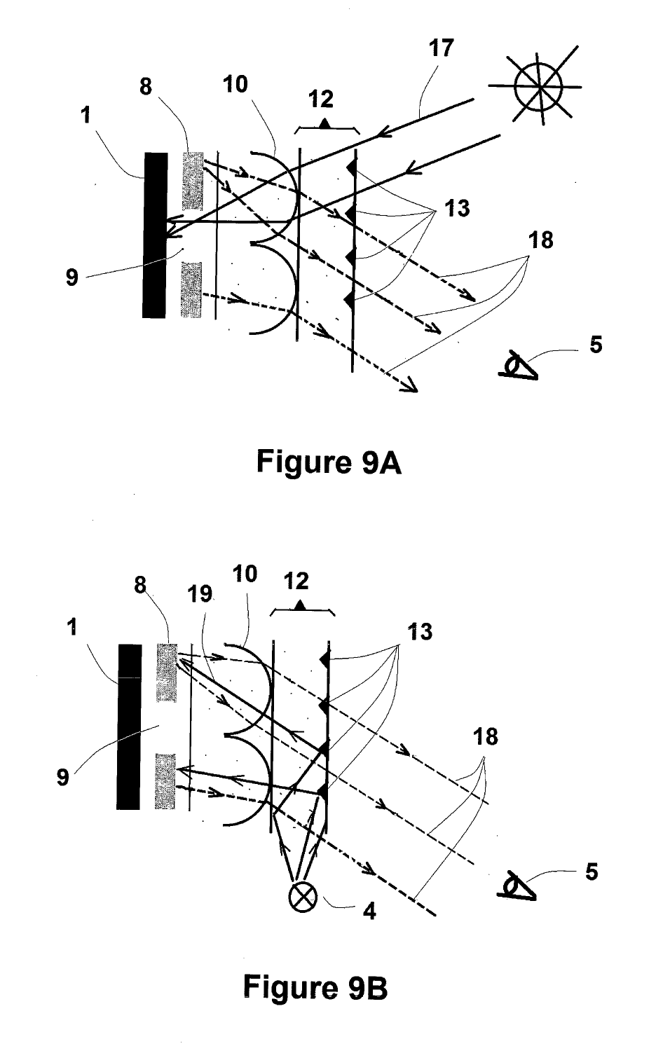

FIG. 9 is a cross-sectional schematic of a preferred variant of the device in FIG. 7, in which the front face of the image is illuminated by a sheet consisting of two optically structured subsheets.

FIGS. 9A and 9B are enlargements of FIG. 9 showing the optical paths of sunlight (FIG. 9A) and the illuminating light (FIG. 9B).

FIG. 10 is a perspective schematic of the device according to the invention when one portion of the image consists of opaque image bands printed on a first subsheet that is lenticular and when a second portion of the image is semitransparent and printed on a second subsheet, the two subsheets and the image being positioned in front of the solar panel.

FIG. 11 is a cross-sectional schematic of the device in FIG. 10, which shows that an observer placed in front of the image will see the superposition of the transparent image of the second subsheet with the opaque image bands of the first subsheet.

FIG. 12 is a cross-sectional schematic of the device according to the invention when the transparent sheet consists of a multitude of colored optical fibers placed in front of the solar panel.

FIG. 1 illustrates the device when it comprises an unapertured solar panel (1), a transparent sheet (2) and an image (3) that is composed of a multitude of opaque image zones separated by completely transparent zones. In this embodiment, the image (3) to be illuminated is printed on the back face of the transparent sheet (2). Said sheet (2) is positioned in front of the solar panel (1) so that its printed face is on the same side as the solar panel (1). In operation, the light emitted by the source (4) (which will for the sake of simplicity be designated the light (4)) and that travels through the interior of the sheet (2) illuminates that face of the image zones which is turned toward the sheet (2), this light scattering in all directions and mainly exiting toward the front of said sheet (2) and therefore toward the observer (5). The light (4) that travels through the interior of the sheet (2) does not exit through the completely transparent zones of the image, thereby enabling a power saving as regards this lighting. Specifically, lighting exterior to the sheet (2) would see some of its light (4) pass through completely transparent spaces without illuminating the image zones.

FIG. 2 illustrates the device according to the invention when it comprises an unapertured solar panel (1), a transparent sheet (2) and an image (3) that is composed of a multitude of semitransparent image zones that are optionally separated by completely transparent zones. In this embodiment, the image (3) is printed on the front face of the transparent sheet (2). Said sheet (2) is positioned in front of the solar panel (1) so that its printed face is on the opposite side to the side that is turned toward the solar panel (1). The image (3) is therefore printed on the same side as the observer (5). In operation, the light (4) that travels through the interior of the sheet (2) illuminates from the back the image zones (3) that are semitransparent so that some of the light (4) passes through said image zones and scatters in all directions outside of the sheet (2), but mainly forward and therefore toward the observer (5). The light (4) that travels through the interior of the sheet (2) does not exit through the completely transparent zones of the image, thereby enabling a power saving as regards this lighting. Specifically, backlighting placed between the solar panel (1) and the printed sheet (2) would see some of its light pass through completely transparent spaces without illuminating the semitransparent image zones, which in addition to wasting energy would dazzle the observer who would therefore see the image (3) less well.

FIG. 3 illustrates the device when it comprises a semitransparent solar panel (6), a transparent sheet (2) and an image (3) composed of a multitude of semitransparent image zones optionally separated by completely transparent zones. In this embodiment of the device, the image (3) is printed on the front face of the transparent sheet (2). Said sheet (2) is positioned behind the solar panel (6) so that its printed face is on the same side as the solar panel (6). The solar panel (6) is made semitransparent for example by virtue of an array of holes or an array of transparent bands through which the light emitted by the image zones (3), which are backlit, passes.

FIG. 4 illustrates the device when it comprises a semitransparent solar panel (6), a transparent sheet (2) and an image (3) composed of a multitude of image zones that are preferably completely opaque and optionally spaced apart by transparent image zones. In this embodiment, the image (3) is printed on the back face of the transparent sheet (2). Said sheet (2) is positioned behind the solar panel (6) with its printed face on the side opposite that facing the solar panel (6). The front face and/or back face of the sheet (2) is optically structured, preferably with an array of micro-lenses (13), stripes, or prisms, so that the light (4) that passes through said sheet (2) and that is scattered by the image (3) exits via this front face in a preferential direction. The solar panel (6) is semitransparent, for example by virtue of an array of micro-holes or an array of transparent bands. The light that exits from the front of the sheet (2) is preferentially directed toward the holes or transparent bands in the solar panel (6) and is perceived by the observer (5).

FIG. 5 illustrates the device when it comprises a semitransparent solar panel (6), a transparent sheet (2) and an image (3) composed of a multitude of semitransparent image zones that are optionally spaced apart by completely transparent zones. This time the image (3) is printed on the front face of the transparent sheet (2). Said sheet (2) is positioned behind the solar panel (6) with its printed face on the same side as the solar panel (6). The front face and/or back face of the sheet (2) is optically structured, preferably with an array of micro-lenses (13), stripes, or prisms, so that the light (4) that exits via this optical structure (13) exits in a preferential direction before passing through said semitransparent image zones (3). The solar panel (6) is semitransparent, for example by virtue of an array of micro-holes or an array of transparent bands. The light (4) that exits from the front of the sheet (2) and that passes through the image zones (3) is preferentially directed toward the orifices or transparent bands of the solar panel (6) and is perceived by the observer (5), so that the image (3) is seen backlit.

FIG. 6 illustrates a variant of the preceding device (FIG. 5) in which the optical array of micro-lenses (10), stripes or prisms, is placed in front of the semitransparent solar panel (6) and in front of the image (3). The carrier of the image (3) makes contact with the front of the sheet (2) and the image is backlit by the light (4) that propagates through the interior of said sheet (2), the light that passes through the image (3) then passing through orifices in the solar panel (6). The optical array of lenses (10) allows the light emitted by the image to be preferentially directed toward the observer (5) and sunlight to be preferentially directed toward the solar collectors and especially toward the photovoltaic cells of the latter if the solar collector is a photovoltaic collector.

One option for this variant (not illustrated) consists in positioning the image zones (3) in front of orifices in the photovoltaic panel or film (6), the latter having been deposited on a transparent carrier forming the sheet (2) at the moment of its manufacture, so that said transparent carrier (2) serves as the sheet (2) and plays the role of light guide for the device.

FIGS. 7 and 8 illustrate the device when it comprises an unapertured solar panel (1) positioned behind the transparent sheet (2) and a semitransparent image that is composed of a multitude of optionally opaque image zones (8) that are printed on the back face of the sheet (2), said image zones (8) taking the form of parallel bands that are spaced apart by completely transparent bands (9). The front face of the sheet (2) is optically structured with an array of parallel convex rectilinear lenses (10). The longitudinal axis of the lenses (10) lies parallel to the image bands (8) so that each lens has a corresponding image band near its focal plane. The front of the image zones (8) is illuminated with light (4) that travels through the interior of the sheet (2), this light being injected via the edge face of one of the two sides of the sheet (2) that lie perpendicular to the longitudinal axis of the lenses (10). This feature allows the light (4) to propagate substantially parallel to the longitudinal axis of the lenses (10), thereby limiting to a value smaller than 45° the angles of incidence on the internal surface of the lenses (10) and therefore causing the light (4) to totally internally reflect even in the interior of said lenses (10). This feature of the lighting (4) allows a better result to be achieved, because the effectiveness of the propagation of the light (4) in the interior of the sheet (2) would not be maintained if the light (4) were injected via the edge face of one of the two other sides of the sheet (2). Each image band (8) that is illuminated in this way from in front, i.e. by light coming from the observer side, scatters light in the interior of the sheet (2) in all directions but mainly in the direction of the observer (5) insofar as light (4) that exits via the lenses (10) is concerned.

FIG. 9 is a preferred variant of the preceding combination (FIG. 8) in which the transparent sheet (2) is composed of two subsheets (7, 12). The first subsheet (7) has its front face structured with an array of convex rectilinear lenses (10) that lie parallel to one another. The second subsheet (12), the faces of which are parallel, is positioned in front of the first subsheet (7) (i.e. on the same side as an observer looking at the device, or on the same side as the sun, the sun illuminating the device). The second subsheet (12) has one or both of its faces optically structured in such a way that the light (4) that travels internally through said second subsheet (12) is scattered (15) toward the lenses (10) of the first subsheet (7) and preferably collimated. For this purpose, the second subsheet (7) comprises microstructures (13), for example taking the form of grooves in the form of prisms, the geometry of which is calculated so that the light reflected by said microstructures exits from the first subsheet (7) substantially in an angular range corresponding to the angular range in which an observer placed in front of the device is liable to see the image bands (8).

The optical paths traced by sunlight and the light from the artificial source (4) are shown in greater detail in FIGS. 9A and 9B.

In FIG. 9A, the light source (4) is not turned on and only light external to the device, for example sunlight (17), strikes the device. This light passes through the second subsheet (12), then reaches the lenses (10) of the first subsheet. The lenses (10) are dimensioned, on the one hand, so that most of the sunlight converges preferentially toward the completely transparent zones (9), so that the sunlight (17) reaches the photovoltaic collector (1) practically without touching the image zones (8), and on the other hand, so that an observer (5) placed in front of the device sees essentially the light rays (18) reflected by the image zones (8), and does not see the photovoltaic collector (1).

In FIG. 9B, the light source (4) has been turned on, which is especially useful at night, or when ambient lighting is poor. Without artificial lighting (4) the image (3) would no longer be easily visible. The light emitted from (4) propagates in the first subsheet (12), which acts as a waveguide, and encounters the microstructures (13) of the latter. These microstructures (13) are calculated in order to deviate the light (4) in rays (19) in the direction of the image zones (8) that, being illuminated, are then visible to the observer by way of light rays (18).

It has been observed that for optimal operation, the light from the source (4) must itself be collimated, and be fed into the transparent sheet (2) or into one or other of its subsheets (7, 12) preferably at an angle smaller than about 30° relative to their surfaces.

This makes it possible to better control the exit angle at which the light emitted by the source (4) is remitted toward the image (3).

Furthermore, by virtue of these arrangements, most of the light emitted by the light source (4) is directed via the microstructures (13) and the lenses (10) toward the image bands (8) without illuminating the photovoltaic panel (1), so that the electrical power required to generate the illumination of the image is typically less, in comparison to known systems.

As may be seen in FIG. 9, the back face of the first subsheet (7) makes contact with a semitransparent image (3), for example image bands (8) positioned facing and in parallel with each of the lenses (10) and spaced apart by completely transparent bands (9), so that the sunlight that passes through the two subsheets (7, 12) is preferably directed toward the completely transparent bands (9) and illuminates the solar panel (1) that is positioned behind the two subsheets (7, 12) and the image (3).

An additional variant consists in making the surfaces of the two subsheets (7, 12) touch so that the top of the lenses (10) of the first subsheet touches the adjacent face of the second subsheet (12). The contacts (14) between the first subsheet (7) and the second subsheet (12) then form optical lines through which the light (4) that propagates in the thickness of the second subsheet (12) may pass and thereby transmit its radiation toward the image (3) and more particularly toward the image bands (8), this being an effective way of illuminating said image (or said image bands) from the front.

FIGS. 10 and 11 illustrate the device according to the invention when it comprises a solar panel (1) that is positioned behind a transparent sheet (2) comprising a first subsheet (7) the front face of which is structured with an array of convex rectilinear lenses (10) that lie parallel to one another. The image is composed, on the one hand, by a multitude of image zones (8), and on the other hand, by image zones (11). The image zones (8) are printed on the back of this first subsheet (7) in the form of parallel image bands (8) spaced apart by completely transparent bands (9). The image zones (11) are printed on a transparent second subsheet (12) the faces of which are parallel and which is positioned in front of the first subsheet (7). The first portion of the printed image (8) is preferably opaque and may for example form the white underprint of the image. The second portion of the printed image is composed of a multitude of semitransparent image zones (11), preferably without the white underprint that ordinarily forms the underlayer that allows color contrast to be increased. This second portion (11) of the image may be printed on the front face or the back face of the second subsheet (12). The first portion (8) of the image zones is illuminated with light (4) that travels through the interior of the first subsheet (7) and/or the interior of the second subsheet (12). The light (4) is injected via the edge face of one of the two sides of the first subsheet (7) that are perpendicular to the longitudinal axis of the lenses and/or via the edge face of at least one of the four sides of the second subsheet (12). This feature allows the light (4) to propagate substantially parallel to the longitudinal axis of the lenses (10), thereby limiting to a value smaller than 45° the angles of incidence on the internal surface of the lenses (10) and therefore causing the light to totally internally reflect even in the interior of said lenses (10). This feature is advantageous because the effectiveness of the propagation of the light (4) in the interior of the first subsheet (7) would not be maintained if the light (4) were injected via the edge face of one of the two other sides of the lenticular subsheet (7). Each image band (8) that is illuminated in this way scatters light in the interior of the first subsheet (7) and this light exits from the lenses (10) in the direction of the second subsheet (12). The light then passes through the second portion (11) of the image which is printed on the second subsheet (12) and in the end the observer (5) perceives a superposition of the first portion (8) of the image and the second portion (11) of the image.

If the first portion of the image (8) consists of opaque white bands and if the second portion (11) of the image consists of a semitransparent image without the white underprint, then the observer (5) will see a high-quality reconstituted image that will be partially reflective and partially emissive. With this combination, sunlight will be not be very strongly absorbed by the second portion (11) of the image because the latter will be very transparent since printed without the white underprint, and sunlight will not be very strongly absorbed by the first portion (8) of the image because the lenses (10) will deviate solar radiation between the image bands (8), through the bands (9) that are completely transparent.

In one variant of this combination, the lenticular first subsheet (7), including the printed image bands (8), and optionally if relevant including the lateral artificial illumination device of said first subsheet (7), is integrated into the front face of said solar panel (1), i.e. this first subsheet (7) is adhesively bonded to the protective front cover of said solar panel (1) or optionally replaces said cover.

FIG. 12 illustrates the illumination device when the solar panel (1) is placed behind a sheet (2) that is composed of a plurality of optical fibers (16). These optical fibers (16) have the property that they transmit the light (4) through their walls, thereby making them light emitting (18). Moreover, since these optical fibers (16) consist of transparent materials, the sunlight (17) that passes therethrough transversely is weakly absorbed thereby, thus allowing the solar panel (1) to remain illuminated by daylight (17) even when said solar panel (1) is covered with these optical fibers (16). These optical fibers (16) are used to transmit light (4) of different colors and are positioned on the surface of the solar panel (1) in order to form colored luminous designs that therefore remain transparent to daylight (17) and visible by the observer (5).

### EXEMPLARY EMBODIMENTS

A first exemplary embodiment according to the embodiment in FIG. 1 comprises a rectangular 72 cm×116 cm photovoltaic solar panel (1) of a power of 100 W and a PMMA sheet (2) of the same area and of 8 mm thickness one of the faces of which has been printed with an image (3) comprising a multitude of completely transparent zones of hexagonal shape and of 4 mm average diameter. The total area of the transparent zones represents 40% of the total area of the solar panel (1).

On the periphery of the sheet (2), on one of the edge faces of the sheet, a strip of light-emitting diodes is placed the light beam (4) of which is directed toward the thickness of the sheet so that said light (4) penetrates into the thickness of said sheet. The face opposite the image (3) is structured with microstripes that lie parallel to one another and the density of which gradually increases so that the light that propagates in the interior of the sheet and that is reflected by these optical microstructures is preferably redirected toward the image (3).

The sheet (2) is positioned in front of the active face of the solar panel (1) with that face on which the image is printed positioned on the same side as the solar panel (1).

An observer who observes the image during the day, through the sheet and at a distance of 5 m does not see the completely transparent zones clearly but only the image (3), which is illuminated by ambient sunlight. At night, the illumination device according to the invention illuminates the front of the image (3) by virtue of the light of the LEDs that propagates in the thickness of the sheet and that is scattered on contact with the ink that makes contact with the back face of the sheet. The artificial light (4) that illuminates the front of the image (3) does not exit through the completely transparent spaces because an air gap of low refractive index is left between the printed sheet (2) and the front cover of the solar panel (1), thereby causing total internal reflection of said light in these locations. The solar panel (1) well exposed to the sun delivers an electrical power of about 60 W, this corresponding to the electrical power calculated for the solar panel when the semitransparent image is positioned in front thereof, but the illumination device of the image that it comprises the transparent sheet and the strip of diodes do not form obstacles to the solar radiation and therefore do not decrease the operating power of the solar panel.

A second exemplary embodiment according to the embodiment in FIGS. 10 and 11 uses the same solar panel (1) as the first exemplary embodiment. This time, the sheet (2) is composed of two subsheets (7, 12) made of PMMA, of area substantially identical to that of the solar panel and of 6 mm thickness. The first subsheet (7) has its front face structured with convex rectilinear lenses (10) that lie parallel to one another and the width of each lens is 2 mm; furthermore, the back face of said first subsheet (7) is printed with white bands (8) of 1 mm width, so that each white band (8) lies parallel to the longitudinal axis of the lenses (10) and is positioned facing one of the lenses (10). The white bands (8) are printed with a metal ink filled with aluminum particles so as to make them very lustrous. Two strips of light-emitting diodes (4) are positioned one on each of the two sides of the subsheet (7) that lie perpendicular to the longitudinal axis of the lenses (10). This position of the entrance of the light (4) into the thickness of the sheet (7) allows said light to propagate all the way along the sheet (7) via multiple reflections from its surface and even from the interior surface of the lenses (10). The light (4) illuminates the white bands (8) that scatter the light toward the front of this first subsheet (7) and exits from the subsheet (7) through the lenses (10). A second subsheet (12) is printed on its back face with an image (11) without the first white underprint layer that is ordinarily applied beforehand. Thus, the image (11) is very transparent. This second subsheet (12) is positioned in front of the first subsheet (7) that is itself positioned in front of the active area of the solar panel (1).

During the day, some sunlight first passes through the second subsheet (12) with little absorption, then passes through the lenses (10) that orient this sunlight toward the transparent bands (9) and the surface of the solar panel (10). Another portion of the sunlight passes through the lenses (10) that orient this other portion of the sunlight toward the white bands (8) that reflect this light forward and therefore through the image (11). An observer will thus see the image (11) in part illuminated directly and in part backlit by ambient sunlight. In fact, during the day the solar panel (1) indeed receives a large part of the light direct from the sun without the illumination device according to the invention forming an obstacle to the entering sunlight.

At night, or in the absence of ambient light, the artificial illumination device illuminates the white bands (8) the light of which is reflected toward the front of the first subsheet (7) and therefore through the image (11). The observer will then see the image (11) backlit by the artificial light (4) reflected from the white bands (8).

### ADVANTAGES OF THE INVENTION

In fact, the invention indeed meets the set aims as it allows an image (3) that is either opaque and positioned behind a semitransparent solar panel (6) or semitransparent and placed in front of an opaque solar panel (1) to be illuminated while ensuring that the illumination device (2, 4) does not form much of an obstacle to the light that illuminates said solar panel (1).

1. A device comprising a solar panel, a transparent sheet acting as a light guide, an image composed of a multitude of opaque or semitransparent image zones separated by completely transparent zones or micro-holes that let said solar panel appear, said image being printed on or placed directly against said transparent sheet, and a light source propagating its light in the thickness of said transparent sheet, wherein said transparent sheet comprises optical means arranged to redirect toward the image zones most of the light injected by said light source.

2. The device as claimed in claim 1, wherein from the point of view of an observer or ambient light, said transparent sheet is located in front of the image, and the latter is located in front of the solar panel.

3. The device as claimed in claim 1, wherein from the point of view of an observer or ambient light, the image is located in front of the transparent sheet, and the latter is located in front of the solar panel.

4. The device as claimed in claim 1, wherein from the point of view of an observer or ambient light, said transparent sheet and the image are located behind the solar panel, the latter then being semitransparent, or provided with micro-holes that let some ambient light pass toward the image.

5. The device as claimed in claim 1, wherein said optical means are located on the front face and/or back face of said transparent sheet and comprise micro-lenses and/or optical microstructures configured so that light that passes through the interior of said transparent sheet exits from the transparent sheet preferentially in the direction of the image zones, in an angular range that corresponds substantially to the angular range of observation of the device by the observer.

6. The device as claimed in claim 5, wherein said microstructures consist of prisms or grooves in the transparent sheet, and in that the total area of said microstructures-represents less than 10% of the total area of said transparent sheet.

7. The device as claimed in claim 1, wherein said transparent sheet is composed of two subsheets, namely a first subsheet having its front face structured with an array of convex rectilinear lenses that lie parallel to one another, and a second subsheet the faces of which are parallel, said subsheet being positioned in front of the first subsheet, i.e. between the first subsheet and an observer or the sun, and having its front face, its back face, or both its faces optically structured with microstructures, the light of said light source being directed toward a lateral edge face of the first subsheet and/or second subsheet.

8. The device as claimed in claim 7, wherein the microstructures of the second subsheet are configured so that the light that is injected into the second subsheet by the light source is preferentially scattered toward the lenses of the first subsheet at an angle such that said lenses redirect the light toward the image zones of the image without reaching the photovoltaic panel.

9. The device as claimed in claim 7, wherein the lenses of the first subsheet are configured so that some ambient light, especially sunlight, is directed by the lenses essentially toward the completely transparent zones of the image so as to illuminate the photovoltaic panel.

10. The device as claimed in claim 7, wherein the surfaces of the two subsheets make contact and form optical lines through which the light that propagates in the thickness of the second subsheet may pass in order then to have its radiation scattered toward the image and more particularly toward the image bands, in order to illuminate said image or said image bands from in front.

11. The device as claimed in claim 1, wherein the solar panel is positioned behind the sheet and said image is on the whole semitransparent and is composed of a multitude of image zones that are optionally themselves opaque and that are printed onto the back face of the sheet (2), said image zones taking the form of parallel bands spaced apart by completely transparent bands, the front face of the sheet being optically structured with an array of convex rectilinear lenses that lie parallel to one another, the longitudinal axis of the lenses lying parallel to the image bands so that each lens has a corresponding image band near its focal plane, the illumination from in front of the image zones being achieved with light that travels through the interior of the sheet, this light being injected via the edge face of one the two sides of the sheet that lie perpendicular to the longitudinal axis of the lenses.

12. The device as claimed in claim 7, wherein the solar panel is positioned behind the transparent sheet composed of two subsheets, said first subsheet being structured on its front face with an array of convex rectilinear lenses that lie parallel to one another, said image being composed of a multitude of image zones a first portion of which, taking the form of parallel bands spaced apart by completely transparent bands, is printed on the back of this first subsheet, and a second portion of which is printed on a transparent second subsheet the faces of which are parallel, said subsheet being positioned in front of the first subsheet, said first portion of the printed image preferably being opaque and preferably white (white underprint) and said second portion of the printed image (colored portion) being composed of a multitude of semitransparent image zones, preferably without the white underprint, this second portion of the image being printed on the front face or on the back face of said second subsheet, the illumination of said first portion of the image zones being achieved with light that is injected via the edge face of one the two sides of the first subsheet that lie perpendicular to the longitudinal axis of the lenses.

13. The device as claimed in claim 12, wherein the second portion of the image is also illuminated, with light that is injected via the edge face of at least one of the four sides of said second subsheet and that travels through the interior of the second subsheet.

14. The device as claimed in claim 13, wherein the first subsheet, including the printed image bands and optionally the lateral illumination device of said first subsheet, is integrated into a protective front cover of the solar panel or replaces said front cover.

15. The device as claimed in claim 1, wherein said transparent sheet or said first and second subsheets are covered with a transparent protective film of low refractive index in order to increase the effectiveness of the light guiding effect.

16. The device as claimed in claim 1, wherein the solar panel is a flexible or stiff, curved or planar, photovoltaic, thermal or hybrid solar collector.

17. The device as claimed in claim 1, wherein the solar panel is a photovoltaic panel and in that its back face is made reflective, for example using the back electrode of the photovoltaic cells when said electrode is made of a metal, especially aluminum, silver or copper.

18. The device as claimed in claim 1, wherein the thickness of the photovoltaic cells, of the sheet, of the subsheets, of the lenses, of the pixels or of components of the lighting may be decreased to about 100 microns.

19. The device as claimed in claim 1, wherein the light source is configured to inject collimated light into the transparent sheet, said light being injected into the transparent sheet or into one or other of the subsheets at an angle smaller than 30° to their surfaces.

20. The device as claimed in claim 1, in which the transparent sheet consists of a sheet of optical fibers of various colors the surfaces of which have light scattering properties.

21. The device as claimed in claim 1, wherein the transparent sheet is stiff or flexible and made of a mineral, organic or synthetic material.

22. The device as claimed in claim 1, wherein the light source is solar or artificial and of any color and any nature, it for example being a filament lamp, an LED lamp, an OLED, a fluorescent strip light, a laser or a neon lamp.

23. The device as claimed in claim 1, wherein when the image is semitransparent, it is made up of colored pixels composed of inks, UV inks, or inks containing phosphorescent or metal additives so that the light is absorbed by one of the front or back faces of the pixels, then re-emitted from the other face of the pixels, possibly with another color.

24. The device as claimed in claim 1, wherein the image is a still or animated electronic image, for example of the LCD, OLED or plasma type, and comprising a surface able to be placed in direct contact with the transparent sheet.
